(19) United States
(12) Patent Application Publication
(10) Pub. No.: US 2014/0050975 A1
(43) Pub. Date: Feb. 20, 2014

(54) NEGATIVE ACTIVE MATERIAL FOR RECHARGEABLE LITHIUM BATTERY AND NEGATIVE ELECTRODE AND RECHARGEABLE LITHIUM BATTERY INCLUDING SAME

(71) Applicant: Samsung SDI Co., Ltd., Yongin-city (KR)

(72) Inventors: Jun-Kyu Cha, Yongin-si (KR); Na-Ri Seo, Yongin-si (KR); Myoung-Sun Kim, Yongin-si (KR); Dong-Ho Son, Yongin-si (KR); Kwi-Seok Choi, Yongin-si (KR)

(73) Assignee: Samsung SDI Co., Ltd., Yongin-city (KR)

(21) Appl. No.: 13/967,147

(22) Filed: Aug. 14, 2013

(30) Foreign Application Priority Data
Aug. 20, 2012 (KR) 10-2012-0090693

(51) Int. Cl. H01M 4/36; H01M 4/62

(52) U.S. Cl. CPC H01M 4/364; H01M 4/36; H01M 4/621; H01M 4/624
USPC 429/209; 252/507

(57) ABSTRACT

Disclosed is a negative active material that includes active material primary particles; a conductive material; and a composite binder.

### CROSS-REFERENCE TO RELATED APPLICATIONS

This application claims priority to and the benefit of Korean Patent Application No. 10-2012-0090693 filed on Aug. 20, 2012 in the Korean Intellectual Property Office, the disclosure of which is incorporated in its entirety herein by reference.

### BACKGROUND

1. Field

This disclosure relates to a negative active material for a rechargeable lithium battery, and a negative electrode and a rechargeable lithium battery including the same.

2. Description of the Related Technology

A rechargeable lithium battery has recently drawn attention as a power source for a small portable electronic device. It uses an organic electrolyte solution and thereby, has twice or more high discharge voltage than that of a conventional battery using an alkali aqueous solution and as a result, has high energy density.

Such a rechargeable lithium battery may include a positive electrode including a positive active material being capable of intercalating and deintercalating lithium and a negative electrode including a negative active material being capable of intercalating and deintercalating lithium in a battery cell and an electrolyte solution injected therein.

A negative electrode includes a current collector and a negative active material layer, and the negative active material layer may be formed by applying a negative active material slurry prepared by mixing a negative active material, a binder, and a conductive material in a solvent followed compressing.

The negative active material may include a carbon-based material such as graphite, but the carbon-based material in general has low capacity and thus, limitedly accomplishes a high-capacity battery.

Accordingly, a metal or a semi-metal capable of alloying with lithium may be used as a negative active material having high capacity instead of the carbon-based material. The metal or semi-metal may include silicon (Si), tin (Sn), aluminum (Al), and the like. However, the metal capable of alloying with lithium may occur short-circuit a conductive path necessary for the charge and discharge and increase a contact resistance among negative active materials and between active material and conductive material due to repetitive expansion and contraction according to intercalation and deintercalation of lithium ions during the charge and discharge, resultantly deteriorating charge and discharge cycle characteristic of the lithium rechargeable battery.

### SUMMARY

Some embodiments provide a negative active material for a rechargeable lithium battery being capable of maintaining conductive properties inside the active material while absorbing volume changes of the active material during charge and discharge.

Another embodiment provides a negative including the negative active material.

Yet another embodiment provides a rechargeable lithium battery including the negative electrode.

According to one embodiment, provided is a negative active material that includes active material primary particles; a conductive material; and a composite binder. In some embodiments, the active material primary particles may include a metal, a semi-metal, an alloy thereof, or an oxide thereof. In some embodiments, the composite binder may include a binder polymer; inorganic particles, organic particles, or combination thereof; and an organic/inorganic binder.

In some embodiments, the negative active material may be porous secondary particles that is an assembly of the active material primary particles, conductive material, and composite binder.

In some embodiments, the active material primary particles may have a volume expansion ratio of greater than or equal to about 50% relative to an initial at a first charge.

In some embodiments, the active material primary particles may include at least one of titanium (Ti), nickel (Ni), silicon (Si), tin (Sn), aluminum (Al), germanium (Ge), lead (Pb), indium (In), zinc (Zn), iron (Fe), copper (Cu), an alloy thereof, an oxide thereof, or a combination thereof. In some embodiments, the active material primary particles may include at least one of titanium (Ti), nickel (Ni), and silicon (Si). In some embodiments, the active material primary particles include titanium (Ti), nickel (Ni), and silicon (Si). In some embodiments, the active material primary particles include from about 60 at % (atomic %) to about 80 at % silicon (Si), from about 10 at % to about 30 at % nickel (Ni), and from about 10 at % to about 30 at % titanium (Ti) based on the total mass of the particles. In some embodiments, the active material primary particles include from about 65 at % to about 75 at % of silicon (Si), from about 15 at % to about 25 at % of nickel (Ni), and from about 15 at % to about 25 at % of titanium (Ti) based on the total mass of the particles.

In some embodiments, the active material primary particles may have an average particle diameter of less than or equal to about 3 μm.

In some embodiments, the composite binder may include the inorganic particle where the inorganic particle comprises metal oxide, semi-metal oxide, a fluorine-based compound, or a combination thereof. In some embodiments, the composite binder may include the inorganic particles, and organic particles that are dispersed in the binder polymer. In some embodiments, the composite binder may include the inorganic particle where the inorganic particle comprises Al₂O₃, SiO₂, TiO₂, SnO₂, CeO₂, NiO, CaO, ZnO, MgO, ZrO₂, Y₂O₃, SrTiO₃, BaTiO₃, MgF, Mg(OH)₂, or a combination thereof.

In some embodiments, the organic/inorganic binder may bind the binder polymer with the inorganic particles and organic particles. In some embodiments, the organic/inorganic binder may bind the binder polymer with organic particles. In some embodiments, the organic/inorganic binder may bind the binder polymer with inorganic particles and organic particles.

In some embodiments, the binder polymer may be emulsion, suspension, or a colloidal binder polymer.

In some embodiments, the binder polymer may include a diene-based polymer, an acrylate-based polymer, a styrene-based polymer, a urethane-based polymer, a polyolefin-based polymer, or a combination thereof.

In some embodiments, the binder polymer may include a styrene-butadiene rubber, an acrylated styrene-butadiene rubber, an acrylonitrile-butadiene rubber, an acrylonitrile-butadiene-styrene rubber, an acrylic rubber, a butyl rubber, a fluorine rubber, polytetrafluoroethylene, polyethylene, polypropylene, ethylenepropylene copolymer, polyethyleneoxide, polyvinylpyrrolidone, polyepichlorohydrine, polyphosphazene, polyacrylate, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinylalcohol, carboxylmethylcellulose, hydroxypropylmethylcellulose, hydroxypropylcellulose, diacetylcellulose, or a combination thereof.

In some embodiments, the inorganic particle may include metal oxide, semi-metal oxide, metal fluoride, metal hydroxide, or a combination thereof. In some embodiments, the inorganic particle may include metal oxide. In some embodiments, the inorganic particle may include semi-metal oxide. In some embodiments, the inorganic particle may include a fluorine-based compound.

In some embodiments, the inorganic particle may include Al₂O₃, SiO₂, TiO₂, SnO₂, CeO₂, NiO, CaO, ZnO, MgO, ZrO₂, Y₂O₃, SrTiO₃, BaTiO₃, MgF, Mg(OH)₂, or a combination thereof.

In some embodiments, the composite binder comprises the organic particles where the organic particles may include polymethylmethacrylate (PMMA), polystyrene (PS), cross-linked polymethacrylate, cross-linked polysyrene, or a combination thereof.

In some embodiments, the organic/inorganic binder may be a hydrolyzed product of a silane coupling agent.

In some embodiments, the silane coupling agent may include an alkoxy group, a halogen, an amino group, a vinyl group, a glycidoxy group, a hydroxyl group, or a combination thereof.

In some embodiments, the silane coupling agent may include vinyl alkylalkoxysilane, epoxy alkylalkoxysilane, mercaptoalkylalkoxysilane, vinylhalosilane, alkylacyloxysilane, or a combination thereof. In some embodiments, the silane coupling agent may be a vinyl alkylalkoxysilane, an epoxy alkylalkoxysilane, a mercaptoalkylalkoxysilane, a vinylhalosilane, an alkylacyloxysilane, or a combination thereof. In some embodiments, the silane coupling agent may be a vinyl alkylalkoxysilane. In some embodiments, the silane coupling agent may be vinyltris(β-methoxyethoxy)silane, γ-methacryloxypropyltrimethoxysilane, glycidoxypropyltriethoxysilane, γ-glycidoxypropyltriethoxy-silane, β-(3,4-epoxycyclohexyl)ethyltrimethoxysilane, γ-glycidoxypropylmethyldiethoxy-silane, γ-aminopropyltriethoxysilane, γ-mercaptopropyltrimethoxysilane, γ-chloropropyltri-methoxysilane, vinyltrichlorosilane, methyltriacetoxysilane, or a combination thereof.

In some embodiments, the composite binder may be included in an amount of about 1 wt % to about 30 wt % based on the total amount of the negative active material.

In some embodiments, the active material primary particles may be included in an amount of about 70 wt % to about 98.9 wt %, and the conductive material may be included in an amount of about 0.1 wt % to about 3 wt %, each based on the total amount of the negative active material.

In some embodiments, the negative active material may have a porosity of about 20 volume % to about 75 volume %.

In some embodiments, the negative active material may include a core region where the active material primary particle is present in a larger amount than the composite binder and a shell region that surrounds the core region and where the composite binder is present in a larger amount than the active material primary particle.

In some embodiments, the negative active material may include the active material primary particle and the composite binder that are uniformly present.

According to another embodiment, a negative electrode for a rechargeable lithium battery including the negative active material and a binder is provided.

According to yet another embodiment, a rechargeable lithium battery including a positive electrode including a positive active material, negative electrode including the negative active material, and an electrolyte is provided.

The negative active material is capable of maintaining conductive properties inside the active material while absorbing volume changes of the active material during charge and discharge. Therefore, cycle-life characteristics of a rechargeable lithium battery may be improved.

### BRIEF DESCRIPTION OF THE DRAWINGS

FIG. 1 is a schematic view of a rechargeable lithium battery according to one embodiment,

FIG. 2 is a schematic view showing one structure of a negative active material according to one embodiment, and

FIG. 3 is a schematic view showing another structure of a negative active material according to another embodiment.

### DETAILED DESCRIPTION

The present disclosure will be described more fully hereinafter with reference to the accompanying drawings, in which exemplary embodiments of this disclosure are shown. This disclosure may, however, be embodied in many different forms and is not construed as limited to the exemplary embodiments set forth herein.

Hereinafter, a negative active material according to one embodiment is described.

In some embodiments, the negative active material includes an active material primary particle, a conductive material, and a composite binder. In some embodiments, the negative active material may be a porous secondary particle that is assembly of the active material primary particle, conductive material, and composite binder.

In some embodiments, the active material primary particles may have large a volume expansion ratio, and for example a volume expansion ratio of greater than or equal to about 50% relative to an initial at a first charge. In some embodiments, the active material primary particles may be at least one selected from the group consisting of a metal, and a semi-metal. In some embodiments, the active material primary particles may be at least one selected from the group consisting of a metal, a semi-metal, an alloy of a metal and an alloy of a semi-metal. In some embodiments, the active material primary particles may be at least one selected from the group consisting of a metal, a semi-metal, an alloy of a metal, an alloy of a semi-metal, an oxide of a metal and an oxide of a semi-metal. In some embodiments, the active material primary particles may be at least one selected from the group consisting of titanium (Ti), nickel (Ni), silicon (Si), tin (Sn), aluminum (Al), germanium (Ge), lead (Pb), indium (In), zinc (Zn), iron (Fe), copper (Cu). In some embodiments, the active material primary particles may be at least one selected from the group consisting of titanium (Ti), nickel (Ni), silicon (Si), tin (Sn), aluminum (Al), germanium (Ge), lead (Pb), indium (In), zinc (Zn), iron (Fe), copper (Cu), or an alloy thereof, or an oxide thereof. In some embodiments, the active material primary particles may include titanium (Ti), nickel (Ni), silicon (Si). In some embodiments, the active material primary particles may include titanium (Ti), nickel (Ni), silicon (Si) in a 15:15:70 ratio. In some embodiments, the active material primary particles may be SiTiNi particles. In some embodiments, the SiTiNi particles may have an average particle diameter of less than or equal to about 3 μm. In some embodiments, the SiTiNi particles may have an average particle diameter of less than or equal to about 1 μm. In some embodiments, the SiTiNi particles may have an average particle diameter of about 0.1 μm to about 3 μm. In some embodiments, the SiTiNi particles may have an average particle diameter of about 0.3 μm to about 1 μm. In some embodiments, the SiTiNi particles may have an average particle diameter of about 0.7 μm.

In some embodiments, the active material primary particles may have an average particle diameter of less than or equal to about 3 μm. In some embodiments, the active material primary particles may have an average particle diameter of about 0.1 μm to about 3 μm. In some embodiments, the active material primary particles may have an average particle diameter of less than or equal to about 1 μm. In some embodiments, the active material primary particles may have an average particle diameter of about 0.3 μm to about 1 μm.

In some embodiments, the active material primary particle may be included in an amount of about 70 wt % to about 98.9 wt % based on the total amount of the negative active material. Within the above range, capacity per gram of a secondary particle is larger (larger than or equal to about 400 mAh/g) than that of graphite may be obtained and a strong secondary particle shape may be provided.

In some embodiments, the conductive material provides a conductive path between the active material primary particles and may be any material having, conductivity without limitation. In some embodiments, the conductive material may be, for example at least one selected from natural graphite, artificial graphite, carbon black, acetylene black, denka black, ketjen black, carbon nanostructure, a carbon fiber, a metal powder or a metal fiber of copper, nickel, aluminum, silver, and the like, and a polyphenylene derivative.

In some embodiments, the conductive material may be included in an amount of about 0.1 wt % to about 3 wt % based on the total amount of the negative active material. Within the above range, conductivity reduction inside the secondary particle caused by the binder may be prevented, and conductivity appropriate for charge discharge may be maintained.

In some embodiments, the composite binder may include a binder polymer, an inorganic particle, and/or an organic particle and organic/inorganic binder.

In some embodiments, the composite binder binds between the active material primary particles, between the active material primary particle and conductive material, and between the conductive materials.

In some embodiments, the binder polymer may be emulsion, suspension, or a colloidal binder polymer. The binder polymer may include a diene-based polymer, an acrylate-based polymer, a styrene-based polymer, a urethane-based polymer, a polyolefin-based polymer, or a combination thereof, for example a styrene-butadiene rubber, an acrylated styrene-butadiene rubber, an acrylonitrile-butadiene rubber, an acrylonitrile-butadiene-styrene rubber, an acrylic rubber, a butyl rubber, a fluorine rubber, polytetrafluoroethylene, polyethylene, polypropylene, ethylenepropylenecopolymer, polyethyleneoxide, polyvinylpyrrolidone, polyepichlorohydrine, polyphosphazene, polyacrylate, polyacrylonitrile, polystyrene, ethylenepropylenedienecopolymer, polyvinylpyridine, chlorosulfonated polyethylene, latex, a polyester resin, an acrylic resin, a phenolic resin, an epoxy resin, polyvinylalcohol, carboxylmethylcellulose, hydroxypropylmethylcellulose, hydroxypropylcellulose, diacetylcellulose, or a combination thereof.

In some embodiments, the binder polymer may be obtained by a well-known emulsion polymerization method or a phase inversion method using polymerizable monomers. The emulsion polymerization method and phase inversion method have no particular limited conditions.

In some embodiments, the polymerizable monomer may include, for example ethylenic unsaturated carbonic acid alkyl ester such as (meth)acrylic acid methyl, (meth)acrylic acid butyl, (meth)acrylic acid ethyl, (meth)acrylic acid-2-ethyl hexyl, and the like; a cyano group-containing ethylenic unsaturated monomer such as acrylonitrile, metacylonitrile, fumaronitrile, α-chloro acrylonitrile, α-cyanoethylacrylonitrile, and the like; a conjugated diene monomer such as 1,3-butadiene, isoprene, 2,3-dimethyl-1,3-butadiene, 2-ethyl-1,3-butadiene, 1,3-pentadiene, chloroprene, and the like; ethylenic unsaturated carboxylic acid and a salt thereof such as acrylic acid, methacrylic acid, maleic acid, fumaric acid, citraconic acid, and the like; aromatic a vinyl monomer such as styrene, an alkyl styrene, vinyl naphthalene, and the like; fluoroalkyl vinyl ether such as fluoro ethyl vinyl ether, and the like; vinyl pyridine; a non-conjugated diene monomer such as vinylnorbornene, dicyclopentadiene, 1,4-hexadiene, and the like; α-olefin such as ethylene, propylene, and the like; an ethylenic unsaturated amide monomer such as (meth)acryl amide and the like; sulfonic acid-based unsaturated monomer such as acryl amide methyl propane sulfonic acid, styrene sulfonic acid, and the like.

In some embodiments, the polymerizable monomer may include a polymerizable monomer having a cross-linking functional group. In some embodiments, the cross-linking functional group may be a cross-linking point during cross-linking of the binder polymer, and for example a hydroxyl group, a glycidyl group, an amino group, an N-methanol group, a vinyl group, and the like. In some embodiments, the polymerizable monomer having the cross-linking functional group may be, for example hydroxy ester of ethylenic unsaturated carboxylic acid such as (meth) acrylic acid hydroxy propyl, (meth) acrylic acid hydroxy ethyl and the like; glycidylester of ethylenic unsaturated carboxylic acid such as glycidyl(meth)acrylate, and the like; amino ester of ethylenic unsaturated carboxylic acid such as dimethyl amino ethyl(meth)acrylate, and the like; methylol group-containing ethylenic unsaturated amide such as N-methylol methacryl amide, N,N-dimethylol methacryl amide, and the like; a monomer including at least two vinyl groups such as ethylene di(meth)acrylate, divinylbenzene, and the like.

In some embodiments, the polymerizable monomer having the cross-linking functional group may be included in an amount of less than or equal to about 5 wt %, and specifically less than or equal to about 2 wt % based on the total amount of the polymerizable monomer.

In some embodiments, the inorganic particle may be a hydrophilic particle having a hydrophilic functional group such as a hydroxyl group at its surface. The hydrophilic particle may increase reactivity between the binder polymer and organic/inorganic binder. In some embodiments, the inorganic particle may have an amorphous phase.

In some embodiments, the inorganic particle may include, for example metal oxide, semi-metal oxide, metal fluoride, metal hydroxide, or a combination thereof. In some embodiments, the inorganic particle may be a hydrophilic particle having a hydrophilic functional group such as a hydroxyl group at its surface. The inorganic particle may include, for example Al₂O₃, SiO₂, TiO₂, SnO₂, CeO₂, NiO, CaO, ZnO, MgO, ZrO₂, Y₂O₃, SrTiO₃, BaTiO₃, MgF, Mg(OH)₂, or a combination thereof.

In some embodiments, the organic particle may be, for example a highly cross-linked polymer having a glass transition temperature (Tg) of more than or equal to about 70° C. In some embodiments, the organic particle may include, for example polymethylmethacrylate (PMMA), polystyrene (PS), cross-linked polymethacrylate, cross-linked polysyrene, or a combination thereof.

In some embodiments, the inorganic particle and the organic particle may have an average particle diameter of about 1 nm to about 1000 nm. In some embodiments, the average particle diameter may range from about 10 nm to about 200 nm. When the average particle diameter is within the above range, preparation process may be easy and an appropriate hardness of the binder may be ensured.

In some embodiments, the inorganic particle and organic particle may be dispersed inside and/or on the surface of the binder polymer.

In some embodiments, at least one of the inorganic particle and organic particle may be included in an amount of about 1 part by weight to about 30 parts by weight based on 100 parts by weight of the binder polymer. Within the above range, at least one of the inorganic particle and organic particle may be included in an amount of about 1 part by weight to about 15 parts by weight.

In some embodiments, the organic/inorganic binder may dispose on at least one part of the inorganic particle and organic particle to bind the binder polymer with the inorganic particle and/or organic particle. In some embodiments, the organic/inorganic binder may cover the inorganic particle and/or organic particle wholly, or may be present partially on the surface of the inorganic particle and/or organic particle in a form of an island.

In some embodiments, the organic/inorganic binder binds the binder polymer with the inorganic particle and/or organic particle and thereby provides the composite binder and the negative active material including the same with high strength. Accordingly, volume changes of the negative active material may be accepted and/or suppressed during charge and discharge and cycle characteristics of a rechargeable lithium battery may be improved.

In some embodiments, the organic/inorganic binder may be a silane-based compound, for example a hydrolyzed product of a silane coupling agent. In some embodiments, the silane coupling agent may be an organic silicon compound having a hydrolytic functional group, and the hydrolytic a functional group may be a functional group being capable of binding with the inorganic particle after hydrolysis.

In some embodiments, the silane coupling agent may include for example an alkoxy group, a halogen, an amino group, a vinyl group, a glycidoxy group, a hydroxyl group, or a combination thereof. In some embodiments, the silane coupling agent may include vinyl alkylalkoxysilane, epoxy alkylalkoxysilane, mercaptoalkylalkoxysilane, vinylhalosilane, an alkylacyloxysilane, or a combination thereof. In some embodiments, the silane coupling agent may be a vinyl alkylalkoxysilane, an epoxy alkylalkoxysilane, a mercaptoalkylalkoxysilane, a vinylhalosilane, an alkylacyloxysilane, or a combination thereof. In some embodiments, the silane coupling agent may be a vinyl alkylalkoxysilane.

In some embodiments, the silane coupling agent may include vinyltris(β-methoxyethoxy)silane, γ-methacryloxypropyltrimethoxysilane, glycidoxypropyltriethoxysilane, γ-glycidoxypropyltriethoxy-silane, β-(3,4-epoxycyclohexyl)ethyltrimethoxysilane, γ-glycidoxypropylmethyldiethoxy-silane, γ-aminopropyltriethoxysilane, γ-mercaptopropyltrimethoxysilane, γ-chloropropyltri-methoxysilane, vinyltrichlorosilane, methyltriacetoxysilane, or a combination thereof, but is not limited thereto. In some embodiments, the silane coupling agent may be vinyltris(β-methoxyethoxy)silane, γ-methacryloxypropyltrimethoxysilane, glycidoxypropyltriethoxysilane, γ-glycidoxypropyltriethoxy-silane, β-(3,4-epoxycyclohexyl)ethyltrimethoxysilane, γ-glycidoxypropylmethyldiethoxy-silane, γ-aminopropyltriethoxysilane, γ-mercaptopropyltrimethoxysilane, γ-chloropropyltri-methoxysilane, vinyltrichlorosilane, or methyltriacetoxysilane.

In some embodiments, the organic/inorganic binder may be included in an amount of about 0.01 parts by weight to about 5 parts by weight based on 100 parts by weight of the binder polymer. Within the above range, it may be included in an amount of about 0.1 parts by weight to about 3 parts by weight.

In some embodiments, the composite binder may be included in an amount of about 1 wt % to about 30 wt % based on the total amount of the negative active material. Within the above range, capacity per gram (larger than or equal to about 400 mAh/g) of a secondary particle is larger than that of graphite may be obtained and a strong secondary particle shape may be provided.

In some embodiments, the negative active material may be a porous secondary particle in which the active material primary particle, the conductive material, and the composite binder are aggregated, and has a plurality of pores. In some embodiments, the negative active material may have a porosity of about 20 volume % to about 75 volume %. When the negative active material has a porosity within the above range, strong secondary particle absorbing expansion of active material therein may be prepared.

In some embodiments, the negative active material may have an average particle diameter of from about 0.1 μm to about 3 μm. In some embodiments, the negative active material may have an average particle diameter of from about 0.3 μm to about 1 μm.

In some embodiments, the negative active material may have various structures depending on a method of preparing the same.

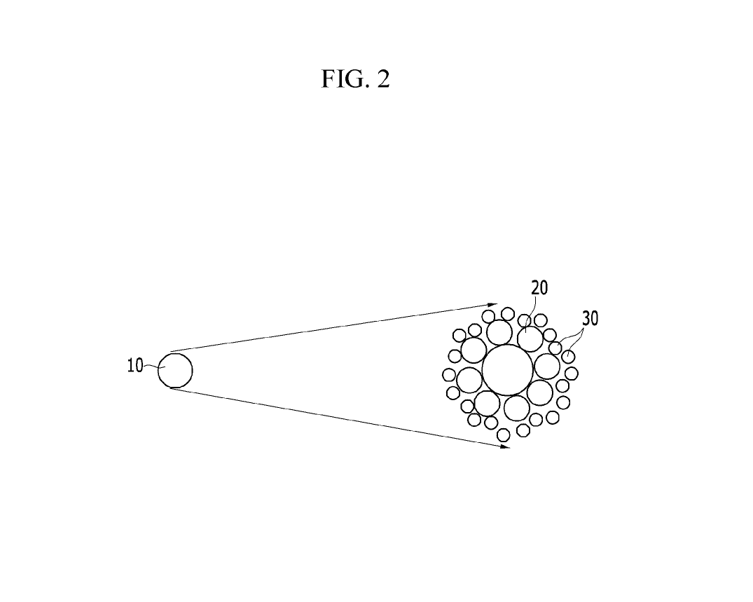

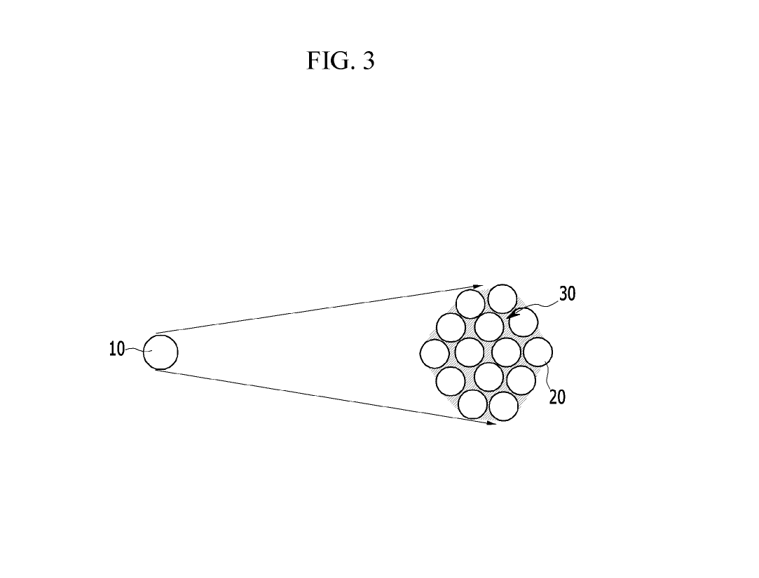

FIG. 2 is a schematic view showing one structure of a negative active material according to one embodiment, and FIG. 3 is a schematic view showing another structure of a negative active material according to another embodiment.

Referring to FIG. 2, a negative active material 10 as a secondary particle may include a core region where a plurality of active material primary particle 20 is present in a larger amount than the composite binder 30, and a shell region that surrounds the core region and where the composite binder 30 is present in a larger amount than the active material primary particle 20.

In some embodiments, the negative active material as a secondary particle may be prepared by putting negative active material slurry including the active material primary particle, the conductive material, and the composite binder in a hot air spray drier and using an atomizer. In some embodiments, the hot air may be in a temperature ranging from about 80° C. to about 200° C., and the atomizer may be spun at a speed of about 5,000 rpm to about 30,000 rpm.

Referring to FIG. 3, a negative active material 10, as a secondary particle may include an active material primary particle 20 which is fixed on a composite binder 30 and is uniformly present.

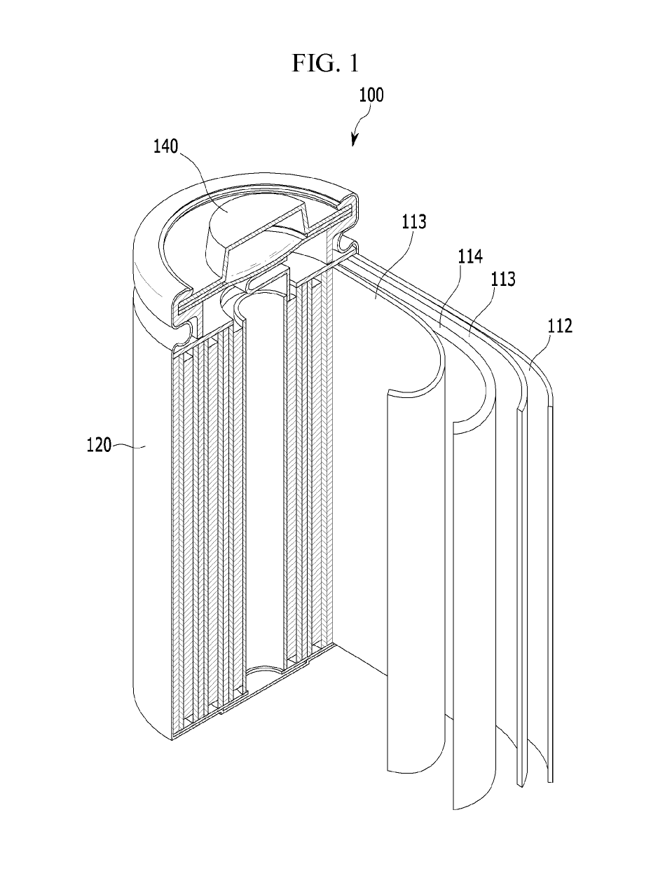

In some embodiments, the negative active material as a secondary particle may be prepared in a fluidized bed process of injecting a negative active material slurry including the active material primary particle, the conductive material, and the composite binder though a spray nozzle into a hot air spray drier and supplying hot air from bottom to top of the spray drier. In some embodiments, the hot air may be in a range of from about 80° C. to about 200° C. [0074] Hereinafter, a rechargeable lithium battery including the negative electrode is described referring to FIG. 1.

FIG. 1 is a schematic view of a rechargeable lithium battery according to one embodiment.

Referring to FIG. 1, a rechargeable lithium battery 100 according to one embodiment includes an electrode assembly including a positive electrode 114, a negative electrode 112 facing the positive electrode 114, a separator 113 interposed between the positive electrode 114 and negative electrode 112, and an electrolyte (not shown) impregnating the positive electrode 114, negative electrode 112, and separator 113, a battery case 120 housing the electrode assembly, and a sealing member 140 sealing the battery case 120.

In some embodiments, the positive electrode 114 may include a current collector and a positive active material layer disposed on at least one side of the current collector.

In some embodiments, the current collector may be aluminum foil.

In some embodiments, the positive active material layer may include a positive active material, a binder, and optionally, a conductive material.

In some embodiments, the positive active material may include a compound that reversibly intercalates and deintercalates lithium (a lithiated intercalation compound). In some embodiments, the positive active material may include a composite oxide of at least one of cobalt, manganese, nickel, or combination thereof, and lithium may be used. Examples may be compounds represented by the following formulae:

LiₐA_{1-b}R_{b}D¹₂(0.90≦a≦1.8 and 0≦b≦0.5);

LiₐE_{1-b}R_{b}O_{2-c}D¹_{c}(0.90≦a≦1.8,0≦b≦0.5 and 0≦c≦0.05);

LiE_{2-b}R_{b}O_{4-c}D¹_{c}(0≦b≦0.5,0≦c≦0.05);

LiₐNi_{1-b-c}Co_{b}R_{c}D¹_{α}(0.90≦a≦1.8,0≦b≦0.5,0≦c≦0.05 and 0<α<2);

LiₐNi_{1-b-c}Co_{b}R_{c}O_{2-α}Z_{α}(0.90≦a≦1.8,0≦b≦0.5,0≦c≦0.05 and 0<α<2);

LiₐNi_{1-b-c}Co_{b}R_{c}O_{2-α}Z₂(0.90≦a≦1.8,0≦b≦0.5,0≦c≦0.05 and 0<α<2);

LiₐNi_{1-b-c}Mn_{b}R_{c}D¹_{α}(0.90≦a≦1.8,0≦b≦0.5,0≦c≦0.05 and 0<α≦2);

LiₐNi_{1-b-c}Mn_{b}R_{c}O_{2-α}Z_{α}(0.90≦a≦1.8,0≦b≦0.5,0≦c≦0.05 and 0<α<2);

LiₐNi_{1-b-c}Mn_{b}R_{c}O_{2-α}Z_{α}(0.90≦a≦1.8,0≦b≦0.5,0≦c≦0.05 and 0<α<2);

LiₐNi_{b}E_{c}G_{d}O₂(0.90≦a≦1.8,0≦b≦0.9,0≦c≦0.5 and 0.001≦d≦0.1);

LiₐNi_{b}Co_{c}Mn_{d}GeO₂(0.90≦a≦1.8,0≦b≦0.9,0≦c≦0.5,0≦d≦0.5 and 0.001≦e≦0.1);

LiₐNiG_{b}O₂(0.90≦a≦1.8 and 0.001≦b≦0.1);

LiₐCoG_{b}O₂(0.90≦a≦1.8 and 0.001≦b≦0.1);

LiₐMnG_{b}O₂(0.90≦a≦1.8 and 0.001≦b≦0.1);

LiₐMn₂G_{b}O₄(0.90≦a≦1.8 and 0.001≦b≦0.1);QO₂;QS₂;LiQS₂;V₂O₅;

LiV₂O₅;LiTO₂;LiNiVO₄;Li_{(3-f)}J₂(PO₄)₃(0≦f≦2);

Li_{(3-f)}Fe₂(PO₄)₃(0≦f≦2);and LiFePO₄.

In the above formulae, A may selected from Ni, Co, Mn, or a combination thereof; R may be selected from Al, Ni, Co, Mn, Cr, Fe, Mg, Sr, V, a rare earth element, or a combination thereof; D¹ may be selected from O (oxygen), F (fluorine), S (sulfur), P (phosphorus), or a combination thereof; E may be selected from Co, Mn, or a combination thereof; Z may be selected from F (fluorine), S (sulfur), P (phosphorus), or a combination thereof; G may be selected from Al, Cr, Mn, Fe, Mg, La, Ce, Sr, V, or a combination thereof; Q may be selected from Ti, Mo, Mn, or a combination thereof; T may be selected from Cr, V, Fe, Sc, Y, or a combination thereof; and J may be selected from V, Cr, Mn, Co, Ni, Cu, or a combination thereof.

In some embodiments, the compounds may have a coating layer on the surface, or may be mixed with another compound having a coating layer. In some embodiments, the coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. In some embodiments, the compound for the coating layer may be amorphous or crystalline. In some embodiments, the coating element included in the coating layer may include Mg, Al, Co, K, Na, Ca, Si, Ti, V, Sn, Ge, Ga, B, As, Zr, or a mixture thereof. In some embodiments, the coating layer may be disposed in a method having no adverse influence on properties of a positive active material by using these elements in the compound. For example, the method may include any coating method such as spray coating, dipping, and the like, but is not illustrated in more detail since it is well-known to those who work in the related field.

In some embodiments, the binder may improve binding properties of the positive active material particles to each other and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In some embodiments, the conductive material may provide an electrode with conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material such as metal powder or metal fiber including copper, nickel, aluminum, silver, and the like; a conductive polymer such as polyphenylene derivative, or a mixture thereof.

In some embodiments, the positive electrode 114 may be fabricated by a method including mixing the positive active material, binder, and conductive material in a solvent to prepare a positive active material slurry and coating the positive active material slurry on a current collector. In some embodiments, the solvent may include N-methylpyrrolidone, and the like, but is not limited thereto.

In some embodiments, the negative electrode 112 may include a current collector and a negative active material layer disposed on at least one side of the current collector.

In some embodiments, the current collector may include one selected from a copper foil, a nickel foil, a stainless steel foil, a titanium foil, a nickel foam, a copper foam, a polymer substrate coated with a conductive metal, and a combination thereof, but is not limited thereto.

In some embodiments, the negative active material layer may include the above negative active material, a binder, and optionally a conductive material.

In some embodiments, the negative active material may be the same as described above. Furthermore, the negative active material may include the above negative active material as a first negative active material, and may further include a carbon material as a second active material. Examples of the carbon material include crystalline carbon, amorphous carbon, or mixtures thereof. The crystalline carbon may be non-shaped, or sheet, flake, spherical, or fiber shaped natural graphite or artificial graphite. The amorphous carbon may be a soft carbon, a hard carbon, a mesophase pitch carbonization product, fired coke, and the like. The mixing ratio of the first negative active material and the second negative active material may be suitably controlled.

In some embodiments, the binder may improve binding properties of negative active material particles with one another and with a current collector. The binder includes a non-water-soluble binder, a water-soluble binder, or a combination thereof.

In some embodiments, the non-water-soluble binder may include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

In some embodiments, the water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. In some embodiments, the cellulose-based compound may include one or more of carboxylmethyl cellulose, hydroxypropylmethyl cellulose, methyl cellulose, or alkali metal salts thereof. In some embodiments, the alkali metal may be Na, K, or Li. In some embodiments, the cellulose-based compound may be included in an amount of about 0.1 parts by weight to about 3 parts by weight based on 100 parts by weight of the negative active material.

In some embodiments, the conductive material may be any electrically conductive material that is generally used in a rechargeable lithium battery. Examples of the conductive material include carbon-based materials such as natural graphite, artificial graphite, carbon black, acetylene black, ketjen black, carbon fibers, and the like; metal-based materials of metal powder or metal fiber including copper, nickel, aluminum, silver, and the like; conductive polymers such as polyphenylene derivatives; or a mixture thereof.

In some embodiments, the negative electrode 112 may be fabricated by a general method of mixing a negative active material, a binder, and optionally a conductive agent in a solvent to prepare a negative active material slurry, and applying the negative active material slurry on a current collector followed by drying and compressing. In some embodiments, the solvent includes N-methylpyrrolidone, and the like, but is not limited thereto.

In some embodiments, the electrolyte includes a non-aqueous organic solvent and a lithium salt.

The non-aqueous organic solvent serves as a medium of transmitting ions taking part in the electrochemical reaction of the battery.

In some embodiments, the non-aqueous organic solvent may be selected from a carbonate-based, ester-based, ether-based, ketone-based, alcohol-based, or aprotic solvent. Examples of the carbonate-based solvent may include, for example dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

In some embodiments, the non-aqueous organic solvent may be used singularly or in a mixture. When the organic solvent is used in a mixture, the mixture ratio can be controlled in accordance with a desirable battery performance.

In some embodiments, the carbonate-based solvent may include a mixture of a cyclic carbonate and a linear carbonate. In some embodiments, the cyclic carbonate and linear carbonate are mixed together in a volume ratio of about 1:1 to about 1:9. When the mixture is used as an electrolyte, it may have enhanced performance.

In some embodiments, the organic solvent according to one embodiment may further include an aromatic hydrocarbon-based solvent as well as the carbonate-based solvent. In some embodiments, the carbonate-based solvents and aromatic hydrocarbon-based solvents may be mixed together in a volume ratio of about 1:1 to about 30:1.

In some embodiments, the aromatic hydrocarbon-based organic solvent may be an aromatic hydrocarbon-based compound represented by the following Chemical Formula 1.

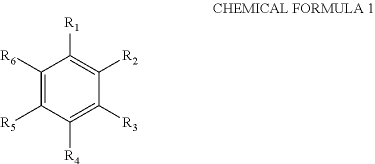

In Chemical Formula 1, R₁ to R₆ are independently hydrogen, a halogen, a C1 to C10 alkyl, a C1 to C10 haloalkyl, or a combination thereof.

In some embodiments, the aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In some embodiments, the electrolyte may further include vinylene carbonate or an ethylene carbonate-based compound represented by the following Chemical Formula 2 to improve cycle life.

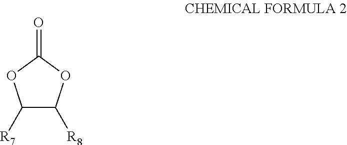

In Chemical Formula 2,

R₇ and R₈ are the same or different and are each independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive for improving cycle life may be flexibly used within an appropriate range.

The lithium salt may be dissolved in an organic solvent, supplies a battery with lithium ions, basically operates the rechargeable lithium battery, and improves transportation of the lithium ions between positive and negative electrodes. Examples of the lithium salt include at least one salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers of 1 to 20, respectively), LiCl, LiI, and LiB(C₂O₄)₂ (lithium bis(oxalato)borate; LiBOB). In some embodiments, the lithium salt may be used in a concentration ranging from about 0.1 M to about 2.0 M. When the lithium salt is included at the above concentration range, an electrolyte may have optimal electrolyte conductivity and viscosity, and may thus have enhanced performance and effective lithium ion mobility.

In some embodiments, the separator 113 may include any materials commonly used in the conventional lithium battery as long as separating the negative electrode 112 from the positive electrode 114 and providing a transporting passage of lithium ion. In some embodiments, the separator 113 may have a low resistance to ion transport and an excellent impregnation for electrolyte. For example, it may be selected from glass fiber, polyester, polyethylene, polypropylene, polytetrafluoroethylene (PTFE), or a combination thereof. It may have a form of a non-woven fabric or a woven fabric. For example, for the lithium ion battery, polyolefin-based polymer separator such as polyethylene, polypropylene or the like is mainly used. In order to ensure the heat resistance or mechanical strength, a coated separator including a ceramic component or a polymer material may be used. Selectively, it may have a mono-layered or multi-layered structure.

In some embodiments, the rechargeable lithium battery may be classified into lithium ion batteries, lithium ion polymer batteries, and lithium polymer batteries according to the presence of a separator and the kind of electrolyte used in the battery. In some embodiments, the rechargeable lithium batteries may have a variety of shapes and sizes and thus, include cylindrical, prismatic, coin-type or pouch-type batteries and also, may be thin film batteries or rather bulky batteries in size. Structures and fabrication methods for lithium ion batteries are well known in the art.

The following examples illustrate the present embodiments in more detail. These examples, however, should not in any sense be interpreted as limiting the scope of the present embodiments.

### Preparation of Negative Active Material

### Preparation Example 1

1 wt % of silica (silica dispersed in water, 30 wt % of a solid) (Aldrich, St. Louis, Mo.), 3 wt % of a styrene-butadiene rubber (SBR) (an emulsion type, 40 wt % of a solid) and 1 wt % of glycidoxypropyltriethoxysilane based on the solids were mixed together and agitated for 24 hours, preparing a composite binder. Then, 94 wt % of SiTiNi particles having an average particle diameter of 0.7 μm (Si:Ti:Ni=70%:15%:15%, 70-STN available from MK electronics Company) and 1 wt % of a conductive material (Mikuni Color Ltd., Hyogo-ken, Japan, carbon black dispersed in water, 20 wt % of a solid) were added thereto, and water was additionally added thereto, preparing slurry including 25 wt % of the entire solid.

The slurry was put in a spray drier capable of blowing a 120° C. dry air to prepare a liquid slurry drop using an atomizer spinning at a speed of 15000 rpm. The liquid slurry drop was dried with a hot air, preparing a negative active material consisting of secondary particles.

### Preparation Example 2

1 wt % of silica (silica dispersed in water, 30 wt % of a solid) (Aldrich), 3 wt % of a styrene-butadiene rubber (SBR) (an emulsion type, 40 wt % of a solid), and 1 wt % of glycidoxypropyltriethoxysilane based on the solids were mixed together and agitated for 24 hour, preparing a composite binder. Then, 94 wt % of an SiTiNi particle having an average particle diameter of 0.7 μm (Si:Ti:Ni=70%:15%:15%, 70-STN available from MK electronic Company) and 1 wt % of a conductive material (Mikuni Color Ltd., carbon black dispersed in water, 20 wt % of a solid) were mixed to prepare slurry including 25 wt % of the entire solid.

The slurry was injected through a spray nozzle into a spray drier blowing a 120° C. dry air, preparing a liquid slurry drop. The liquid slurry drop was dried through a fluidized bed process of blowing a hot air from bottom to top of the spray drier, preparing a negative active material consisting of secondary particles.

### Comparative Preparation Example 1

A negative active material formed of coagulated SiTiNi particles (Si:Ti:Ni=70%:15%:15%) with an average particle diameter of 0.7 μm was prepared.

### Comparative Preparation Example 2

A negative active material was prepared according to the same method as Preparation Example 1 except for using 4 wt % of a styrene-butadiene rubber (SBR) instead of silica to prepare a composite binder.

### Fabrication of Rechargeable Lithium Battery Cell

### Example 1

LiCoO₂ as a positive active material, polyvinylidene fluoride (PVDF) as a binder, and carbon as a conductive agent were mixed in a weight ratio of 92:4:4, and the mixture was dispersed in N-methyl-2-pyrrolidone, preparing positive slurry. This slurry was coated on a 20 μm-thick aluminum foil and then, dried and compressed, fabricating a positive electrode.

The negative active material according to Preparation Example 1, graphite, a styrene-butadiene rubber as a binder, and carboxylmethyl cellulose as a thickener were mixed in a weight ratio of 10:87:2:1, and the mixture was dispersed in water, preparing negative active material slurry. This slurry was coated on a 15 μm-thick copper foil and then, dried and compressed, fabricating a negative electrode.

The positive and negative electrode and a polyethylene separator were used to fabricate a pouch-type rechargeable lithium battery cell. The electrolyte solution was prepared by mixing ethyl carbonate (EC)/ethylmethylcarbonate (EMC)/diethylcarbonate (DEC) in a volume ratio of 3/5/2 and including LiPF₆ in a concentration of 1.3M.

### Example 2

A rechargeable lithium battery cell was fabricated according to the same method as Example 1 except for using the negative active material according to Preparation Example 2 instead of the one according to Preparation Example 1.

### Comparative Example 1

A rechargeable lithium battery cell was fabricated according to the same method as Example 1 except for using the negative active material according to Comparative Preparation Example 1 instead of the one according to Preparation Example 1.

### Comparative Example 2

A rechargeable lithium battery cell was fabricated according to the same method as Example 1 except for using the negative active material according to Comparative Preparation Example 2 instead of the one according to Preparation Example 1.

### Evaluation

Evaluation 1: Fracture of Secondary Particle

The negative electrodes were evaluated to determine if secondary particles therein maintained their shape using a scanning electronic microscope (SEM). The results are shown in Table 1.

TABLE 1

| | Fracture of secondary particle |
|---|---|
| Example 1 | ⊚ |
| Example 2 | ⊚ |
| Comparative Example 1 | X |
| Comparative Example 2 | X |

⊚: Good (maintenance),
X: Fracture

Evaluation 2: Initial Efficiency and Cycle-Life Characteristic

The rechargeable lithium battery cells according to Examples 1 and 2 and Comparative Examples 1 and 2 were constant current charged at 25° C. with 0.05 C up to a voltage of 4.35V (vs. Li) and then, constant voltage charged up to a current of 0.02 C while the voltage of 4.35V was maintained. Then, the rechargeable lithium battery cells were discharged with a constant current of 0.05 C up to a voltage of 2.75V (vs. Li) during the discharge (formation process),

Then, constant current charged at 25° C. with 0.7 C up to a voltage of 4.35V (vs. Li) and constant voltage charged up to a current of 0.02 C while the voltage of 4.35V was maintained, and discharged with a current of 0.5 C down to a voltage of 2.75V (vs. Li) during the discharge, of which the cycle was 100 times repeated.

Table 2 shows the charge and discharge efficiency of the rechargeable lithium battery cells in the formation process and their capacity retention after the 100 time charge and discharges related to the initial charge and discharge.

TABLE 2

| | Charge and discharge | |
|---|---|---|
| | efficiency (%) | Capacity retention (%) |
| Example 1 | 88.5 | 80 |
| Example 2 | 89.0 | 83 |
| Comparative Example 1 | 83.0 | 30 |
| Comparative Example 2 | 85.0 | 45 |

Referring to Table 2, the rechargeable lithium battery cells according to Examples 1 and 2 had improved initial efficiency and cycle-life characteristics compared with the ones according to Comparative Examples 1 and 2.

Evaluation 3: Electrode Expansion Ratio

Half cells were fabricated by using each of the negative electrode and the electrolyte according to Examples 1 and 2, and Comparative Examples 1 and 2, and a Li metal counter electrode. The half cells were constant current charged at 25° C. with 0.05 C up to a voltage of 0.01V (vs. Li) and constant voltage charged down to a current of 0.01 C while the voltage of 0.01V was maintained. The half cells were decomposed to compare expansion ratios between their initial electrodes and the electrodes after the expansion. The results are provided in Table 3.

TABLE 3

| | | Thickness of | |
|---|---|---|---|
| | Thickness of initial | electrode after | Expansion |
| | electrode (μm, except | expansion (μm, except | ratio |
| | substrate) | substrate) | (%) |
| Example 1 | 54 | 79 | 46.3 |
| Example 2 | 54 | 78 | 44.4 |
| Comparative | 54 | 82 | 51.9 |
| Example 1 | | | |
| Comparative | 54 | 81 | 50.0 |
| Example 2 | | | |

*Expansion ratio (%) = ((thickness of electrode after expansion/thickness of initial electrode) − 1) * 100

Referring to Table 3, the rechargeable lithium cells according to Examples 1 and 2 had an improved expansion rate compared with ones according to Comparative Examples 1 and 2.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative active material, comprising
active material primary particles including at least one of a metal, a semi-metal, an alloy thereof, and an oxide thereof;
a conductive material; and
a composite binder.

2. The negative active material of claim 1, wherein the composite binder comprises a binder polymer; an organic/inorganic binder; inorganic particles, organic particles, or a combination thereof.

3. The negative active material of claim 1, wherein the active material primary particles have a volume expansion ratio of greater than or equal to about 50% relative to an initial time at a first charge.

4. The negative active material of claim 1, wherein the active material primary particles comprise at least one of titanium (Ti), nickel (Ni), silicon (Si), tin (Sn), aluminum (Al), germanium (Ge), lead (Pb), indium (In), zinc (Zn), iron (Fe), copper (Cu), an alloy thereof, an oxide thereof, or a combination thereof.

5. The negative active material of claim 1, wherein the active material primary particles have an average particle diameter of less than or equal to about 3 μm.

6. The negative active material of claim 1, wherein the active material primary particles comprise titanium (Ti), nickel (Ni), and silicon (Si).

7. The negative active material of claim 6, wherein the active material primary particles include from about 60% to about 80% silicon (Si), from about 10% to about 30% nickel (Ni), and from about 10% to about 30% titanium (Ti) based on the total mass of the particles.

8. The negative active material of claim 7, wherein the active material primary particles include from about 65% to about 75% of silicon (Si), from about 15% to about 25% of nickel (Ni), and from about 15% to about 25% of titanium (Ti) based on the total mass of the particles.

9. The negative active material of claim 2, wherein the binder polymer comprises a diene-based polymer, an acrylate-based polymer, a styrene-based polymer, a urethane-based polymer, a polyolefin-based polymer, or a combination thereof.

10. The negative active material of claim 9, wherein the binder polymer comprises a styrene-butadiene rubber, an acrylated styrene-butadiene rubber, an acrylonitrile-butadiene rubber, an acrylonitrile-butadiene-styrene rubber, an acrylic rubber, a butyl rubber, a fluorine rubber, polytetrafluoroethylene, polyethylene, polypropylene, ethylenepropylenecopolymer, polyethyleneoxide, polyvinylpyrrolidone, polyepichlorohydrine, polyphosphazene, polyacrylate, polyacrylonitrile, polystyrene, ethylenepropylenedienecopolymer, polyvinylpyridine, chlorosulfonated polyethylene, latex, a polyester resin, an acrylic resin, a phenolic resin, an epoxy resin, polyvinylalcohol, carboxylmethylcellulose, hydroxy-propylmethylcellulose, hydroxypropylcellulose, diacetylcellulose, or a combination thereof.

11. The negative active material of claim 2, wherein the composite binder comprises the inorganic particles where the inorganic particles comprise metal oxide, semi-metal oxide, a fluorine-based compound, or a combination thereof.

12. The negative active material of claim 11, wherein the composite binder comprises the inorganic particles where the inorganic particles comprise Al₂O₃, SiO₂, TiO₂, SnO₂, CeO₂, NiO, CaO, ZnO, MgO, ZrO₂, Y₂O₃, SrTiO₃, BaTiO₃, MgF, Mg(OH)₂, or a combination thereof.

13. The negative active material of claim 1, wherein the composite binder comprises the organic particles where the organic particles comprise polymethylmethacrylate (PMMA), polystyrene (PS), cross-linked polymethacrylate, cross-linked polysyrene, or a combination thereof.

14. The negative active material of claim 2, wherein the organic/inorganic binder is a hydrolyzed product of a silane coupling agent.

15. The negative active material of claim 14, wherein the silane coupling agent is a vinyl alkylalkoxysilane, an epoxy alkylalkoxysilane, a mercaptoalkylalkoxysilane, a vinylhalosilane, an alkylacyloxysilane, or a combination thereof.

16. The negative active material of claim 1, wherein the composite binder is included in an amount of about 1 wt % to about 30 wt % based on the total amount of the negative active material.

17. The negative active material of claim 1, wherein the active material primary particles are included in an amount of about 70 wt % to about 98.9 wt %, and the conductive material is included in an amount of about 0.1 wt % to about 3 wt %, each based on the total amount of the negative active material.

18. The negative active material of claim 1, wherein the negative active material has a porosity of about 20 volume % to about 75 volume %.

19. A negative electrode for a rechargeable lithium battery, comprising
the negative active material according to claim 1, and
a binder.

20. A rechargeable lithium battery, comprising
a positive electrode including a positive active material,
a negative electrode comprising the negative active material according to claim 1, and
an electrolyte.
